(19) United States
(12) Patent Application Publication
(10) Pub. No.: US 2013/0037566 A1
(43) Pub. Date: Feb. 14, 2013

(54) MONITOR FOR PARTICULATE MATTER IN DISPENSING CONTAINER

(71) Applicant: Michael J. BOHM, Shawano, WI (US)

(72) Inventor: Michael J. BOHM, Shawano, WI (US)

(21) Appl. No.: 13/208,270

(22) Filed: Aug. 11, 2011

(51) Int. Cl. G01F 23/36

(52) U.S. Cl. 222/51; 222/1; 222/23

(57) ABSTRACT

An apparatus and method for monitoring the level of particulate material in a container and providing a human perceivable signal when the material reaches a predetermined reduced level as it is dispensed from the container.

### FIELD OF THE INVENTION

The invention relates generally to dispensing of particulate matter, and more particularly to a sensing device for deteiuiining the level of such matter during the course of dispensing the material.

### BACKGROUND OF THE INVENTION

Sand, salt, or a sand and salt mixture, are often dispensed from dump trucks and dump truck snow plows to make roads which have become slippery with snow or ice, or both, less slippery and more safely passable.

When the dump body of a truck is filled and starts out on the road, the dispenser apparatus, of which there may be several types, has a load of the particulate material to dispense out of the truck and spread onto the road. Since the surface of the material in the truck body will become sloped during the natural course of dispensing, generally due to gravity, eventually there will be no material to dispense at the back end of the truck, where the dispenser resides, while there may be as much as 40 or 50% of the capacity of the truck body still occupied by the particulate material. Dispensing may continue until the truck body is empty by tilting the body of the dump truck in a normal fashion.

However, the truck driver cannot see how the load behind him is shaped and can only guess at when he needs to start raising the front of the body to feed the material into the dispensing apparatus. An alternative to guessing is to stop the truck, climb up and view the shape of the load in the truck body.

There are disadvantages to both methods. If the guess is too high about how much material has been dispensed, the driver runs the risk of spilling part of the load by raising the front of the body too early. If it is late, a length of road may be left untreated, thereby creating a dangerous condition. If an automobile driver is confident that an otherwise slippery road has been treated with the usual particulate material he will drive somewhat differently than he would on a known untreated road. Thus, a stretch of unintentionally untreated roadway following after a treated road surface, without warning, can be extra dangerous.

The drawbacks to the visual inspection are several, some of which are also safety related. A snowplow/dump truck stopping in the middle of the road during the plowing and surface treating process is an obvious danger to other traffic. Having to stop and visually inspect the load results also in lost time and unneeded discomfort for the driver during a long period of road clearing and treating.

### SUMMARY OF THE INVENTION

A purpose of embodiments of the invention is to enable a truck driver to be able to know when the front of the body needs to be raised in order to keep the particulate material flowing until the full load has been expanded, without having to stop until he has reached a safe or purposeful place to stop.

A sensor device which responds to the presence or absence of particulate material at its location in the truck body provides information that is important to the truck driver.

### BRIEF DESCRIPTION OF THE DRAWING

The purposes, advantages, and features of embodiments of the invention will be more clearly perceived from the following detailed description, when read in conjunction with the accompanying drawing, wherein;

FIG. 1 is a perspective view of a dump truck with a prior art example of a dispensing apparatus;

FIG. 2 is a rear view of a similar dump truck with an example of a different prior art dispenser;

FIG. 3 is a perspective view of a sensor/transmitter example in accordance with an embodiment of the invention;

FIG. 4 is a partial perspective view of a truck body showing the particulate material dispensing apparatus in relation to the sensor/transmitter of FIG. 3;

FIG. 5 is a partial side schematic view of the dispensing apparatus and the sensor/transmitter of FIG. 4;

FIG. 6 is a schematic side view of a truck body fully loaded, and showing the dispenser and sensor/transmitter of FIG. 4;

FIG. 7 is a view similar to that of FIG. 6, showing a portion of the load expended;

FIG. 8 is another view similar to that of FIG. 6, showing the sensor/transmitter in a signaling position;

FIG. 9 is a schematic view of a switch circuit that can be used in the sensor/transmitter of FIG. 3; and

FIG. 10 is a schematic view similar to FIG. 9 with a different angle actuating arm.

### DETAILED DESCRIPTION OF DRAWING

With reference now to the drawing, and more particularly to prior art FIGS .1 and 2, there are shown examples of conventional dump trucks 11 and 12. Truck 12 is equipped with snow plow blade 13. Truck 11 could also be equipped with a plow of some known type.

At the back of body 14 of truck 11 are two spreader elements 15 which may be fed by an auger or some other dispensing apparatus (not shown here) with the particulate material in body 14.

At the back of differently shaped body 16 of truck 12 is central spreading apparatus 17, which can also be fed particulate material by a conventional auger dispenser or the like (not shown here).

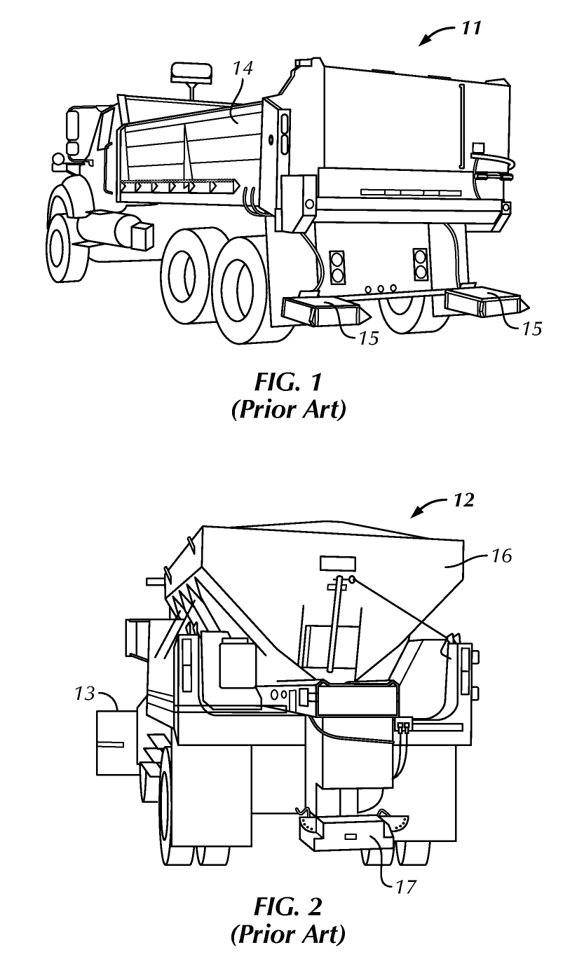

The trucks shown in FIGS. 1 and 2 are merely two examples of prior art trucks with known material dispensers.

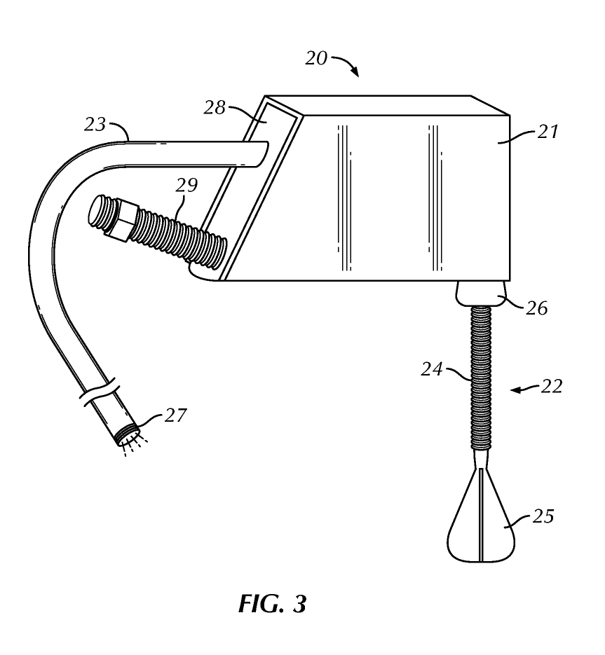

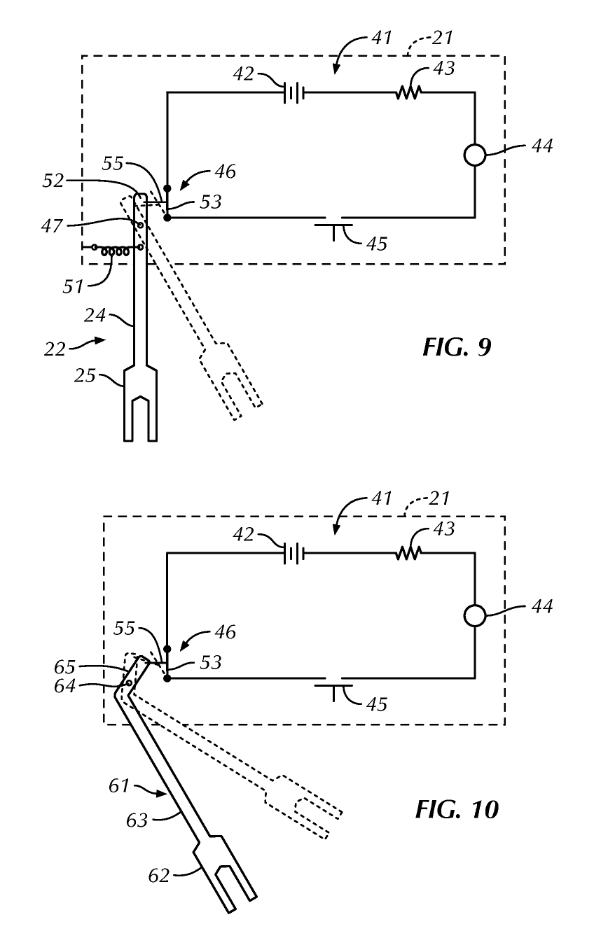

An embodiment of the invention is shown in FIGS. 3-5. Sensor/transmitter 20 has casing 21 which contains the electro-mechanical mechanism which converts the motion of physical sensor element 22 into electrical signals, which can be transmitted over cable 23, for example. Alternatively, such electrical signals can be wirelessly transmitted. Examples of the mechanism coupled in a simple circuit are shown in FIGS. 9 and 10. It is contemplated that casing 21 will be coated or dipped in appropriate material to protect it in a hostile environment.

The sensor element comprises a relatively stiff rod which can move from side to side by a detectable amount. The rod is shown surrounded by a coil spring and the combination of rod and spring will be referred to as stem 24. At the end of stem 24 is a paddle 25. While the paddle is shown as having vanes, similar to the vanes on a game dart, it can have any shape which will react to force from particulate material pushing against it.

Within casing 21 is a conventional pressure or motion sensor (not shown) and simple circuitry (see FIGS. 9 and 10). If stem 24 is firmly held at base 26 to casing 21, a pressure sensor within the casing or the base can sense the stress at that connection when paddle 25 is subject to a lateral force. Alternatively, as shown, stem 24 includes a rigid rod within the outer coil spring shown, which rod extends into casing 21 and activates a switch connected to the electronic circuitry therein.

When the circuitry in casing 21 senses force on or motion of paddle 25 by whatever means, it emits a signal over cable 23, which may be connected to signal element 27 in the cab of the truck. By this means, the truck driver will be notified of a change of position of paddle 25 and can act accordingly.

Alternatively, the electrical signal can cause a light, or a sound, or other physical or observable indicator. Element 27 can be any device which provides some perceivable indication that paddle 25 has moved by a predetermined amount or has been subject to a predetermined lateral force.

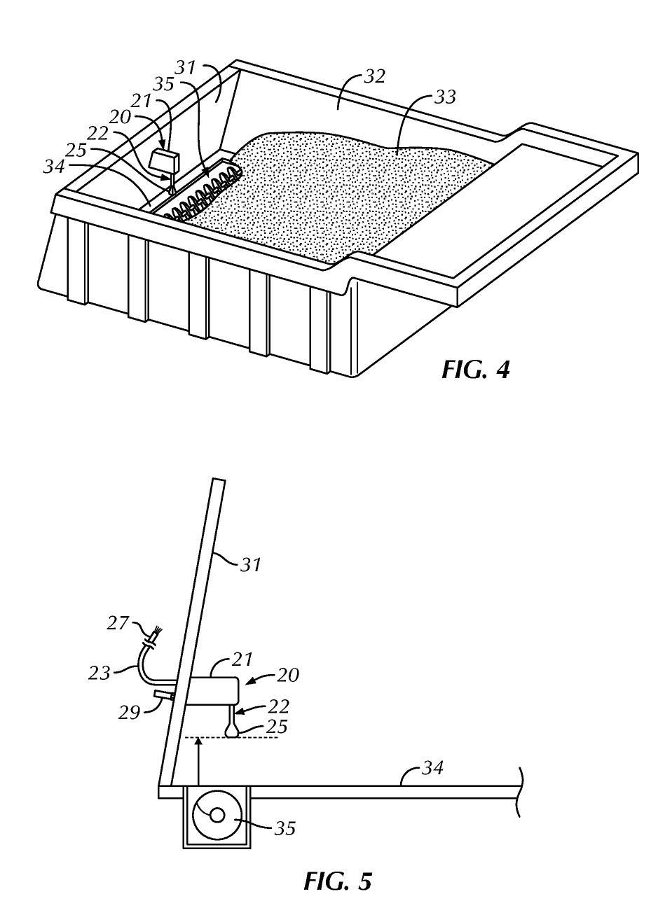

With reference to FIGS. 4 and 5, sensor/transmitter 20 is mounted to tailgate 31 at the rear end of truck body 32 which contains particulate material 33. Bolt 29 is an exemplary means for such attachment. In floor 34 of the truck body is mounted auger 35, for example. Any type of particulate material feeding device can be used, and an auger is a suitable known device for that purpose. Many truck tail gates are tilted, as shown in FIGS. 5-8 and for that reason, surface 28 of casing 21 is at an equivalent angle. If it is intended that casing 21 be mounted to a vertical or perpendicular surface, face 28 would not be at an angle as shown.

Casing 21 is mounted to tailgate 31 so that the bottom end of paddle 25 is above floor 34 by a few inches, represented by the vertical arrow in FIG. 5. It has been found that six inches is a functional position, but it could be more or less, depending on the granularity of the particulate material, whether it is wet or dry, and other factors. The purpose of this positioning will be made clear below. It is possible that sensor/transmitter 20 can be mounted to end or tail gate 31 in a manner that permits vertical adjustment.

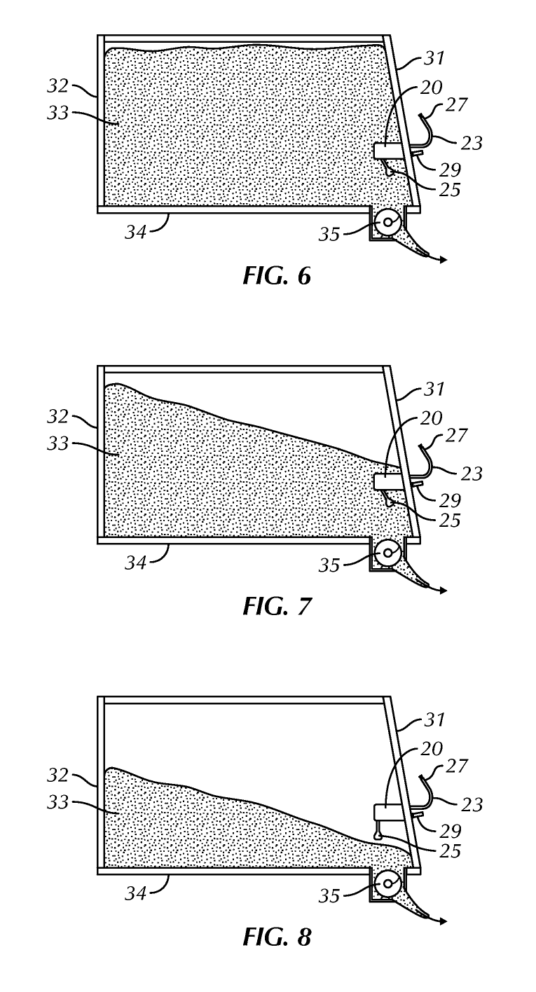

The functioning of switch/transmitter 20 is depicted in FIGS. 6-8. With switch 20 in place and paddle 25 in a neutral position, as in FIG. 3, material 33 is loaded into body 32. As the material fills the body, paddle 25 is forced toward tailgate 31, essentially loading the switch.

As the load is dispensed, the top surface of the particulate material will take the form shown in FIG. 7. When partially emptied, paddle 25 is still biased or forced toward the rear, so there is no signal transmitted to the driver.

The particulate material continues to be dispensed over time and eventually paddle 25 starts to experience reduced rearward force and tends to start straightening. At or about the time that material 33 ceases to exert any significant force on paddle 25, the switch/transmitter reaches an active or closed position that causes the circuitry in casing 21 to convert the force or movement of stem 24 to a signal. This tells the driver that, even though particulate material continues to be fed out by the dispenser, is it time to, and is safe to, raise the front of body 32 so that material 33 continues to be fed out of the body by auger 35. Note that in the embodiment shown, cable 23 extends out through tailgate 31, and is then fed by an appropriate route to the truck cab.

When the front of the body is raised, material 33 again engages and forces paddle 25 rearwardly, effectively resetting switch/transmitter 20. The next time the signal reaches the driver, body 32 is essentially empty and the driver knows the snow or ice melting effect of his load of material has been ended. The driver then completes his shift or returns to base for another load of particulate material.

Examples of alternative embodiments of the electro-mechanical mechanism inside casing 21 are shown in FIGS. 9 and 10. A simple circuit 41 comprises battery 42, resistor 43, signaling element 44, on/off switch 45, and signaling switch 46. Understanding that FIG. 9 is a simple schematic example, sensor element 22 is shown pivoted about pivot point 47 and is biased into a generally vertical position (as seen in FIG. 9) by spring 51 which can be anchored between casing 21 and stem 24. End 52 of stem 24 is positioned with respect to switch element 53 so that when vane 25 swings clockwise to the left, end 52 of the arm which is connected to switch element 53, moves the switch element into a position to close switch 46, thereby activating circuit 41 so that element 44 produces a signal which alerts the truck driver that the particulate material load is in such condition that the front of the truck body needs to be raised in order to continue dispensing the material in an uninterrupted manner. Element 44 is a representation of signal element 27.

An alternative electro-mechanical mechanism is shown in FIG. 10. Instead of employing a biasing spring, this embodiment uses gravity as the biasing force. Sensor element 61 has force receiving end 62, which may be weighted and vane-shaped as shown in FIG. 3, stem 63, and activating end 65, all pivoted about pivot point 64. The gravity biased and activated position of sensor element 61 is with end 65 in a position to closed switch 46. When the truck body is loaded, the force of the particulate material on vane 62 moves arm 63 and switch element 53 counter-clockwise to the unactivated position shown in dotted lines. As the load is dispensed, and the force of the material on vane 62 is reduced, gravity will tend to swing stem 63 clockwise, thereby closing switch 46 by the action of end 65 on switch element 53.

On/off switch 45 can be a simple push-button mounted in the side of casing 21, which would be engaged to close the circuit just before the truck body is loaded. As loading progresses, arm 24, 63 is swung counter-clockwise and switch 46 is opened.

While the signal generated by circuit 41 by signal producing element 44 is shown by FIG. 3 as being transmitted over cable 23, it could also be wirelessly transmitted to a receiver in the truck cab to provide a human perceivable signal. Not only might the signal be a light or a sound, it could be a message on a screen in the cab. Any conventional radio-type transmitter/receiver arrangement could be used for such a wireless signal.

The structure described above is by way of example only. The truck body may have any suitable shape to function along with an appropriate dispenser and material spreader. The switch/transmitter can be made of any appropriate material that is resistant to the corrosive characteristics of the particulate material and the weather. The particulate material is not limited to sand, or salt, or a mixture thereof, but could be seeds, fertilizer, or any other particulate material that is applied by spreading.

What is claimed is:

1. Apparatus for monitoring particulate material in a container having a floor and dispenser apparatus mounted in the floor, the monitoring apparatus comprising:
a sensor/transmitter having an element sensitive to a predetermined change of position;
a relatively rigid arm projecting outwardly from said sensor/transmitter;
means for biasing said arm to effect a closed switch condition;
means for coupling said arm to said sensitive element in a manner to effect a change of position in said sensor/transmitter;
means for mounting said sensor/transmitter to the container so that said arm projects into the particulate material in the container and is moved by force of the particulate material to a loaded condition and moves to the closed condition as the level of particulate material is reduced as it is dispensed from the container; and
signal means connected to said sensor/transmitter to provide a signal when said arm moves by said biasing means back to the closed condition.

2. The apparatus according to claim 1, wherein said biasing means is a spring.

3. The apparatus according to claim 1, wherein said biasing means is the force of gravity.

4. The apparatus according to claim 1, wherein when mounted to the container, a distal end of said arm is at a predetermined distance above the container floor.

5. The apparatus according to claim 1, wherein the signal is audible.

6. The apparatus according to claim 1, wherein the signal is visible.

7. The apparatus according to claim 1, wherein the signal is both visable and audible.

8. The apparatus according to claim 1, wherein the signal is electronic.

9. The apparatus according to claim 1, and further comprising an electrical circuit of which said sensor/transmitter is a part.

10. A method for signaling a predetermined change of load level of particulate material in a container having a floor where the load level change results from the particulate material being dispensed by a dispenser apparatus, a signaling device comprising a sensor/transmitter having an element sensitive to a predetermined change of position, a relatively rigid arm connected to the sensor/transmitter and biased to an active condition, means for coupling said arm to said sensitive element in a manner to effect a change of position in said sesnsor/transmitter, and signal means connected to said sensor/transmitter to provide a signal when said arm moves by said biasing means back to the closed condition, the method comprising:
mounting the sensor/transmitter in the container adjacent to the dispenser with the arm projecting into the body of the container, the container being configured to hold a supply of the particulate material on the floor thereof;
filling the container with particulate material, whereby the arm is moved to a loaded condition by force on the arm caused by the particulate material; and
dispensing the particulate material to a reduced level at the sensor/transmitter until the bias overcomes the force of the particulate material on the arm;
whereby the arm reverts to the active condition under the force of the bias and the sensor/transmitter is energized to activate the signal means.

11. The method according to claim 10, wherein the arm has a distal end, the method further comprising mounting the sensor/transmitter in the container with the distal end at a predetermined distance above the container floor.
